(19) United States
(12) Patent Application Publication
(10) Pub. No.: US 2025/0177978 A1
(43) Pub. Date: Jun. 5, 2025

(54) METHODS AND DEVICES FOR PREPARING AND ANALYZING EMBEDDED TISSUES

(71) Applicant: Queen's University at Kingston, Kingston (CA)

(72) Inventors: Malek Hassan, Kingston (CA); Haidy Metwally, Oakville (CA); Richard D. Oleschuk, Kingston (CA)

(21) Appl. No.: 18/964,059

(22) Filed: Nov. 29, 2024

Related U.S. Application Data
(60) Provisional application No. 63/604,627, filed on Nov. 30, 2023.

(51) Int. Cl. B01L 3/00; G01N 1/44

(52) U.S. Cl. CPC B01L 3/502715; G01N 1/44; B01L 2300/0867; B01L 2300/18

(57) ABSTRACT

A device for preparing a tissue for analysis includes a first conduit adapted to transport at least one solvent, the first conduit having a distal opening that delivers the at least one solvent to a selected location on the tissue, a second conduit adapted to collect a sample comprising the at least one solvent and an analyte/metabolite from the tissue and transport the sample to at least one of a waste disposal, a storage container, and a sample analyzer. The device may be configured to directly sample an embedded tissue, and may include a heater that heats the at least one solvent to a temperature that melts the embedding medium, wherein the collected sample comprises the at least one solvent, liquified embedding medium, and an analyte/metabolite. The device allows direct analysis of the tissue at the selected location, without removing the embedding medium from the entire tissue section.

### RELATED APPLICATION

This application claims the benefit of the filing date of Application No. 63/604,627, filed on Nov. 30, 2023, the contents of which are incorporated herein by reference in their entirety.

### FIELD

The invention relates to the use of preserved biological tissues in biochemical analyses. More specifically, the invention relates to methods for preparing embedded tissues for analysis by selectively removing embedding media at one or more locations and directly analyzing the tissue at the one or more locations.

### BACKGROUND

Biological tissue samples harbor valuable information that enhances research. In clinical settings, swift and precise identification or profiling of various molecules, such as lipids, proteins, and peptides, can be a crucial step in accurate diagnosis and subsequent treatment. Numerous diseases, such as cancer and diabetes, exhibit distinctive metabolomic profiles. Tissues can be preserved in various ways, such as fresh-frozen tissue sections, optimal cutting temperature (OCT) polymer embedded tissue sections, and formalin-fixed paraffin-embedded (FFPE) tissue blocks or sections on slides being common methods. Fresh frozen tissue sections demand immediate freezing in liquid nitrogen and storage at extremely low temperatures, making them expensive and less stable in the long term. Archived biospecimens are routinely stored in FFPE tissue blocks or sections on slides. FFPE-stored tissues can be a valuable source for histopathological and immunohistochemistry studies.

An advantage of FFPE tissues is they can be easily sectioned, which is convenient for imaging methods. However, the labor-intensive process of tissue preparation, especially the removal of paraffin, remains a time-consuming step. In addition, deparaffinization can affect the quality of the tissue used in histopathology or other techniques [1]. There are various methods to dewax paraffin from the tissue sections; the most common is aggressive solvent extraction regimes using xylene [2], hexane [3], and paraffin oil [4]. In addition, boiling water minimizes the harm caused by toxic solvents like xylene and hexane [4-6]. Some groups used distilled water with or without dishwashing soap to dewax the tissues [7]. After paraffin removal, hydration of the tissue is accomplished using different washing protocols depending on the sample, for example using concentrations of ethanol ranging from 70-100% [8]. Another way to remove paraffin that avoids excessive use of xylene and ethanol uses stainless steel (SS) slides to repel the paraffin wax and enhance its solubility in neutral pH of low amounts of xylene [3], but has the drawback of the high expense of SS slides. A method using hot air was proposed, but requires further investigation as preliminary work used a household hair dryer as the heat source [9].

There is significant interest in methods for removing paraffin not only for histopathological diagnostics but also for mass spectrometry (MS) or MS imaging (MSI) studies. MS has emerged as a powerful tool in biomarker discovery, tumor classification, and uncovering the underlying mechanisms related to diseases. Various mass spectrometry techniques can be used to characterize tissues that are obtained from FFPE sections such as liquid extraction surface analysis (LESA), matrix-assisted laser desorption ionization (MALDI), water assisted laser desorption ionization mass spectrometry (WALDI), and desorption electrospray ionization mass spectrometry (DESI) along with nano-DESI. It is desirable to analyze FFPE tissue section using mass spectrometry with minimal to no post sectioning procedure. A recent study by Bunch and co-workers showed that using atmospheric-pressure infrared laser-ablation plasma photoionization (AP-IR-LA-PPI) source combined with MS imaging allowed the direct analysis of FFPE tissue sections without dewaxing [10]. It is an innovative way for imaging of FFPE tissue sections using matrix-free MALDI but the method requires specialized equipment and training to operate the laser, and is time consuming.

### SUMMARY

According to a broad aspect of the invention there is provided a device for preparing a tissue for analysis, comprising: a first conduit adapted to transport at least one solvent, the first conduit having a distal opening that delivers the at least one solvent to a selected location on the tissue; a second conduit adapted to collect a sample comprising the at least one solvent from the tissue and transport the sample to at least one of a waste disposal, a storage container, and a sample analyzer.

According to one aspect of the invention there is provided a device for preparing an embedded tissue section for analysis, comprising: a first conduit adapted to transport at least one solvent, the first conduit having a distal opening that delivers the at least one solvent to a selected location on the embedded tissue section; a heater proximal to the distal opening of the first conduit, the heater adapted to heat the at least one solvent to a temperature sufficient to melt an embedding medium at the selected location on the tissue section; a second conduit adapted to collect and transport the at least one solvent and liquified embedding medium and/or extracted metabolite(s), analyte(s), etc. away from the selected location on the tissue section.

In one embodiment the device comprises a controller that regulates the temperature of the heater.

In one embodiment the first conduit and the second conduit are substantially coaxial; wherein the second conduit is inside the first conduit.

In one embodiment the device comprises a positioning apparatus; wherein the device is removably attached to the positioning apparatus; wherein the positioning apparatus provides adjustment of a position of the device along one or more of X, Y, and Z axes; wherein the positioning apparatus enables positioning of the distal opening of the device at the selected location on the tissue section.

In one embodiment the second conduit is adapted to be connected to a mass spectrometer; wherein the device enables mass spectrometry analysis at the selected location of the tissue section without removing the embedding medium from other locations of the embedded tissue section.

In various embodiments the mass spectrometry analysis is selected from, but is not limited to, liquid extraction surface analysis (LESA), water assisted laser desorption ionization mass spectrometry (WALDI), desorption electrospray ionization mass spectrometry (DESI), nano-DESI, matrix-assisted laser desorption ionization (MALDI), electrospray ionization mass spectrometry (ESI), electron ionization (EI), atmospheric chemical ionization (APCI), liquid chromatography-mass spectrometry (LC-MS), capillary electrophoresis-mass spectrometry (CE-MS), or gas chromatography-mass spectrometry (GC-MS).

In one embodiment the embedding medium comprises paraffin.

In one embodiment the embedded tissue section comprises a formalin-fixed paraffin-embedded (FFPE) tissue.

According to another aspect of the invention there is provided a mass spectrometry probe comprising a device as described herein.

According to another of the invention there is provided a method for preparing an embedded tissue section for analysis, comprising: using a first conduit to transport at least one solvent, the first conduit having a distal opening that delivers the at least one solvent to a selected location on the embedded tissue section; disposing a heater proximal to the distal opening of the first conduit, the heater adapted to heat the at least one solvent to a temperature sufficient to melt an embedding medium at the selected location on the embedded tissue section; using a second conduit to collect and transport the at least one solvent and liquified embedding medium away from the selected location on the tissue section; wherein the embedding medium is removed from the tissue section only at the selected location.

One embodiment may comprise regulating the temperature of the heater to maintain the at least one solvent at the temperature sufficient to melt the embedding medium at the selected location on the tissue section.

One embodiment may comprise subjecting the at least one solvent and liquified embedding medium collected from the selected location on the tissue section by the second conduit to a mass spectrometry analysis. In various embodiments the mass spectrometry analysis may be selected from, but is not limited to, liquid extraction surface analysis (LESA), water assisted laser desorption ionization mass spectrometry (WALDI), desorption electrospray ionization mass spectrometry (DESI), nano-DESI, matrix-assisted laser desorption ionization (MALDI), electrospray ionization mass spectrometry (ESI), electron ionization (EI), atmospheric chemical ionization (APCI), liquid chromatography-mass spectrometry (LC-MS), capillary electrophoresis-mass spectrometry (CE-MS), or gas chromatography-mass spectrometry (GC-MS).

In one embodiment the method may comprise using a positioning apparatus to adjust a position of the device along one or more of X, Y, and Z axes; wherein the positioning apparatus enables positioning of the distal opening of the device at the selected location on the embedded tissue section.

In various embodiments the method enables mass spectrometry analysis at the selected location of the embedded tissue section without removing the embedding medium from other locations of the embedded tissue section.

In one embodiment of the method the embedding medium comprises paraffin.

In one embodiment of the method the embedded tissue section comprises a formalin-fixed paraffin-embedded (FFPE) tissue.

According to another of the invention there is provided a sampling method for extracting and/or isolating one or more metabolites and/or analytes from an embedded tissue section or other material such as, e.g., bacterial cultures, fungal cultures, cell line cultures, etc., for analysis, comprising: using a first conduit to transport at least one solvent, the first conduit having a distal opening that delivers the at least one solvent to a selected location on the embedded tissue section; disposing a heater proximal to the distal opening of the first conduit, the heater adapted to heat the at least one solvent to control the extraction temperature at the selected location on the material; using a second conduit to collect and transport the sample comprising the at least one solvent and extracted metabolite(s)/analyte(s) away from the selected location on the material to isolated collection vials for subsequent analysis.

One embodiment may comprise regulating the temperature of the heater to maintain the at least one solvent at the temperature sufficient to melt the embedding medium at the selected location on the material.

One embodiment may comprise subjecting the sample comprising the at least one solvent and extracted metabolite(s)/analyte(s) collected from the selected location on the material by the second conduit to a mass spectrometry analysis. In various embodiments the mass spectrometry analysis may be selected from, but not limited to, direct injection-mass spectrometry (DI-MS), flow injection analysis-mass spectrometry (FIA-MS), and liquid chromatography-mass spectrometry (LC-MS), capillary electrophoresis-mass spectrometry (CE-MS), or gas chromatography-mass spectrometry (GC-MS).

In one embodiment the method may comprise using a positioning apparatus to adjust a position of the device along one or more of X, Y, and Z axes; wherein the positioning apparatus enables positioning of the distal opening of the device at the selected location on the material.

In various embodiments the method enables mass spectrometry analysis of the selected location of extraction of the material without prior preparation or removing the embedding medium from other locations of the embedded material.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIGS. 1A and 1B are diagrams of workflows for sample preparation, according to embodiments.

FIG. 2 is diagram of a workflow for analysis of a sample, according to an embodiment.

FIG. 3 is a photograph of a probe setup including a probe holder, an LMJ-SSP, a thermometer, and a heating element, according to an embodiment.

FIG. 4 is a carrier liquid temperature calibration curve.

FIG. 5 is a plot showing the effect of temperature of the probe on deparaffinization, represented by the area under the curve of m/z 885.5.

FIG. 6 is a plot showing effect of the carrier liquid on the obtained MS signal, represented by the area under the curve of m/z 885.5.

FIG. 7 is a plot showing effect of electrospray ionization (ESI) temperature on the area under the curve of m/z 885.5.

FIG. 8 is a plot showing effect of the sampling time on the analysis, represented by the area under the curve of m/z 885.5.

FIG. 9 shows plots of mass spectra of FFPE pork liver deparaffinized and analyzed directly according to one embodiment (lower plot), after conventional deparaffinization using xylene (middle plot), after deparaffinization and rehydration (upper plot).

FIG. 10 shows plots of m/z 885.5 of repetitive sampling of the same spot on FFPE calf liver tissue (upper plot), and percentage area under the curve of each repetitive sampling normalized to the first sampling (lower plot).

FIG. 11A is a photomicrograph of melanoma FFPE tissue section under analysis; FIGS. 11B-11D are heatmaps for markers at m/z 885.5, m/z 281.2, and m/z 585.3, respectively.

FIG. 12A is a plot showing K-means clustering (3 groups) of a principal component analysis (PCA) of the image pixels (i.e., spectra) of melanoma FFPE tissue; FIG. 12B shows the normalized average spectra of each cluster generated by K-means; and FIG. 12C is s heatmap of the clusters.

FIGS. 13A and 13B are plots of mass spectrometry results for samples from fresh-frozen (FF) beef and pork liver using a sample extraction technique according to an embodiment described herein.

FIGS. 14A and 14B are plots of mass spectrometry results for samples from benign and cancer cell lines and a blank using a sample extraction technique according to an embodiment described herein.

FIGS. 15A and 15B are plots of mass spectrometry results for samples from bacterial and fungal cultures using a sample extraction technique according to an embodiment described herein.

### DETAILED DESCRIPTION OF EMBODIMENTS

One aspect of the invention relates to devices and methods for preparation of embedded tissues and tissue sections for analysis. In general, as used herein, the term “embedded” refers to a tissue specimen or section that has been preserved by embedding in an embedding medium. An embedding medium may comprise one or more polymers, one or more waxes, or combinations thereof. Examples of embedding media include, but are not limited to, optimal cutting temperature (OCT) polymer, paraffin, and available products such as Paraplast™, Paramat™, and Polyfin®. According to embodiments, preparation of embedded tissue sections includes removal of the embedding medium from the tissue section; for example, removal of paraffin (i.e., deparaffinization) from a formalin-fixed paraffin-embedded (FFPE) tissue section. Advantageously, embodiments provide for localized removal of the embedding medium at one or more discrete locations or spots on an embedded tissue without removing embedding medium from the rest of the tissue, thereby preserving the rest of the tissue for future use and analysis. Embodiments may also be used to prepare an entire embedded tissue.

Another aspect of the invention relates to devices and methods for preparation of embedded tissues and tissue sections and direct analysis. According to embodiments, an embedded tissue section may be prepared by removing the embedding medium and analyzed, e.g., using MS, MSI, etc. with the same device. Embodiments enable preparation and analysis of an embedded tissue at a discrete spot without disturbing the rest of the embedded tissue. Furthermore, since preparation and analysis of the embedded tissue may be carried out substantially in a single step, the speed and efficiency of analyzing embedded tissue sections is greatly enhanced. Whereas devices and methods are described herein primarily with reference to localized deparaffinization and direct analysis of FFPE tissue sections, it will be appreciated that embodiments may be readily adapted for preparation and analysis of other embedded tissues, such as OCT polymer embedded tissues.

Embodiments are described herein primarily with respect to the analysis of “tissue” and tissue sections. It will be appreciated that the terms “tissue” and “tissue section” may refer to any type of material that may be analyzed according to the methods and techniques described herein wherein a liquid sample comprising one or more analytes, metabolites, etc., is collected from the material. For example, the material may be biological tissue, cells, etc. Biological tissue and/or cells may be animal, plant, fungal, bacterial, etc., and combinations thereof.

Devices and methods according to certain embodiments for preparation of embedded tissues comprise a heated microfluidic device. The microfluidic device may comprise a surface sampling probe with ambient ionization capability that can be used with MS to directly analyze, profile, and/or image samples without the need for sample preparation. Such a device may be referred to as a liquid microjunction surface sampling probe (LMJ-SSP), examples of which are described in and in International Patent Application Publication No. WO 2022/256941. Embodiments described herein enhance and broaden the capability and utility of LMJ-SSP by enabling localized preparation of embedded tissues, e.g., deparaffinization and cleaning of FFPE samples, facilitating single-spot sample analysis and providing a valuable tool for sample preparation that significantly reduces or eliminates sample preparation prior to LMJ-SSP analysis. Various mass spectrometry techniques may be used to analyze and characterize a prepared sample, such as liquid extraction surface analysis (LESA), matrix-assisted laser desorption ionization (MALDI), water assisted laser desorption ionization mass spectrometry (WALDI), desorption electrospray ionization mass spectrometry (DESI), nano-DESI, liquid chromatography—mass spectrometry (LC-MS), capillary electrophoresis—mass spectrometry (CE-MS), or gas chromatography—mass spectrometry (GC-MS).

Typically, an LMJ-SSP has two coaxial tubes wherein the outer tube is connected to a syringe pump and delivers a solvent (i.e., carrier liquid) to the distal ends of both tubes which are substantially co-terminus. A liquid dome is formed at the terminus of the tubes due to the surface tension of the liquid. The liquid forming the dome is continually drawn into the inner tube which is connected at the proximal end to a mass spectrometer (e.g., the electrospray ionization (ESI) source of the mass spectrometer). To control the solvent flow, the solvent flow from a syringe pump is balanced with the Venturi effect generated by the flow of N₂ gas as used for MS analysis, or by the flow of air in a solvent trap in the case of using the probe for sample preparation only, i.e., removing embedding medium only. However, for use in embedded tissue sample preparation only it is not necessary to rely on the vacuum/Venturi effect generated, and instead a stronger pump may be used to increase speed and efficiency of removing embedding medium from embedded tissue sections.

The LMJ-SSP was originally designed to function as a sample introduction probe for MS, facilitating the transfer of a liquid sample directly from the semi-solid or solid sample (typically biological tissue) surface to the mass spectrometer through the carrier liquid. The liquid microjunction of the probe contacts the liquid microjunction, enabling solid-liquid extraction to occur.

However, to directly analyze embedded tissue samples with an LMJ-SSP a significant challenge arises due to the presence of embedding medium acting as a barrier between the carrier liquid and the tissue sample surface. This barrier impedes the extraction of metabolites by preventing the carrier liquid from accessing the tissue. Embodiments described herein overcome this challenge by raising the temperature of the carrier liquid (also referred to herein as “solvent”) above the melting point of the embedding medium. Upon contacting the embedded tissue, the heated liquid carrier liquefies the embedding medium, allowing it to be readily transferred away, as waste, or into the mass spectrometer where it is evaporated by the high ESI temperature. This process leaves the tissue exposed to the liquid microjunction, facilitating solid-liquid extraction without encountering a physical barrier.

An important aspect of this approach is maintaining the temperature of the carrier liquid above the melting point of the embedding medium throughout the entire analysis. The temperature must be accurately controlled within a narrow range that is sufficient to melt the embedding medium but not so high as to cause the carrier liquid to boil. Through experimentation it was found that the temperature of the carrier liquid may be accurately regulated by heating it at the terminus of the LMJ-SSP. An embodiment is described in detail in the below examples.

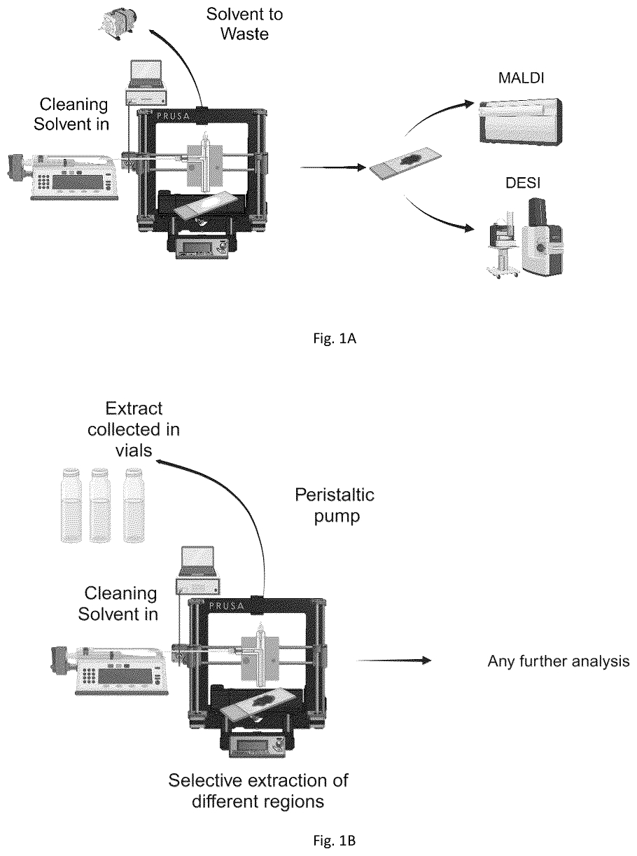

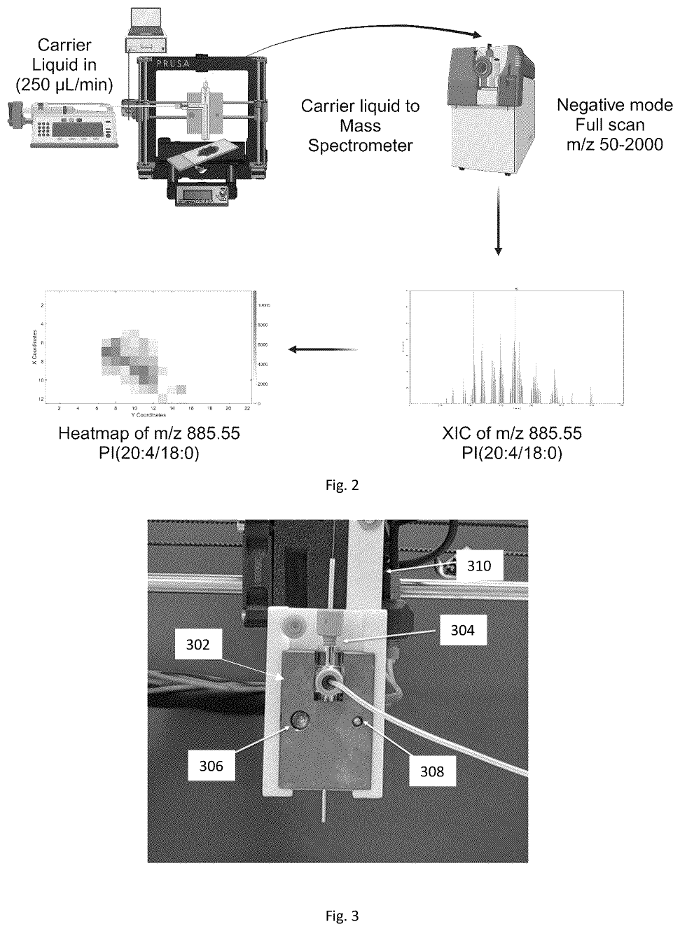

As described in the below, based on the example of FFPE tissue sections, embodiments may be employed (1) for FFPE sample preparation by providing the capability to directly deparaffinize the tissue at one or more specific location (i.e., spot) on the tissue, without having to deparaffinize the entire tissue, so that the collected sample can subsequently be subjected to a desired analysis (see, e.g., the diagrammatic representation of an embodiment in FIG. 1A). Referring to FIG. 1A, the sample collected from the FFPE tissue during an initial portion of a sampling period contains solubilized paraffin and it may be directed to waste, and during a subsequent portion of the sampling period the collected sample may contain little or no solubilized paraffin and may be directed to a sample analyzer (e.g., MALDI, DESI, etc.). Embodiments may also be employed (2) for direct FFPE sample preparation and analysis by providing the capability to directly analyze the sample collected at the deparaffinized spot of the tissue using the same probe (e.g., the diagrammatic representation of an embodiment in FIG. 2). In applications where a different type of analysis is used or when mass spectrometry is not the analytical method of choice, embodiments based on (1) FFPE sample preparation are particularly valuable. Sample preparation only (1) may be achieved, e.g., by connecting the inner capillary of the LMJ-SSP probe to a vacuum source through a solvent trap to collect the carrier liquid as waste (e.g., FIG. 1). The deparaffinization process may be optimized thermally and selectively by adjusting the temperature, the duration of deparaffinizing, and the type of deparaffinizing solvent.

Preliminary testing began with liver samples from different animals to optimize the technique. The optimized technique was then used to study clinical samples, particularly melanoma cancer, as described in detail in Example 3 below. Because of the non-invasiveness of deparaffinization, the method offers insights into differentiating between neoplastic and non-neoplastic tissue in melanoma. The results demonstrate the effectiveness of a heated LMJ-SSP embodiment in providing a rapid and reliable method for dewaxing and analyzing single spots, thereby preserving the bulk of the embedded tissue sample for storage while providing substantially single-step preparation (deparaffinization) and analysis of a PPFE sample.

Another aspect of the invention relates to devices and methods for preparation of samples from non-embedded tissues and direct analysis. Here, “non-embedded” refers to tissues that do not comprise an embedding medium either because an embedding medium has been removed or because the tissue was never embedded, i.e., the tissue is fresh, fresh-frozen, snap-frozen, etc. According to such embodiments, an example of which is shown diagrammatically in FIG. 1B, a sample may be collected from a tissue and deposited into a suitable storage format such a small vial, etc., for later analysis and/or subjected to direct analysis using an analytical technique such as, for example, LESA, MALDI, WALDI, DESI, nano-DESI, LC-MS, CE-MS, or GC-MS. Embodiments allow for targeted regional or spatial extraction rather than a bulk extraction of the tissue, enhancing the spatial selectivity of the extraction/sample collection and preserving the rest of the tissue for further analysis. Embodiments according to this aspect may utilize a microfluidic probe such as a LMJ-SSP to sample localized, single spot, or specific regions of interest of the tissue.

Applications include, but are not limited to, analysis of different regions in tissue (e.g., to separately sample cancerous and benign regions of a tissue), to differentiate, identify, and/or characterize different cell lines in culture medium or different bacterial and fungal colonies in culture medium, and for in vivo extraction of metabolites, bacterial infections, etc. In particular, an embodiment configured as a handheld unit using a biologically safe solvent (e.g., water) may be used to extract clinical samples during surgery or other procedures, allowing for early and rapid detection of cancer, infections, etc.

Embodiments are further described by way of the following non-limiting examples.

### Example 1

This example describes a heated LMJ-SSP probe according to an embodiment, and its use in direct deparaffinization and analysis of FFPE tissue sections when connected to the electrospray source of a mass spectrometer (e.g., FIG. 2).

As noted above, it was found that the temperature of the carrier liquid may be accurately regulated by heating it at the LMJ-SSP. To achieve this, a prototype was made as shown in the photograph of FIG. 3. A copper chassis 302 was machined and carefully fitted to the probe 304. The copper chassis housed a heating element 306 and temperature sensor 308 to enable precise temperature control through custom-built controller software. This setup ensured a seamless and controlled temperature environment for effective paraffin liquefaction at the liquid microjunction and subsequent sample analysis.

The observed temperature fluctuation of the copper chassis which controlled the temperature of the carrier liquid inside the LMJ-SSP was less than 1° C. Although there may be a slight variation between the temperature of the flowing carrier liquid and the temperature of the copper chassis, this was minimal and did not affect performance.

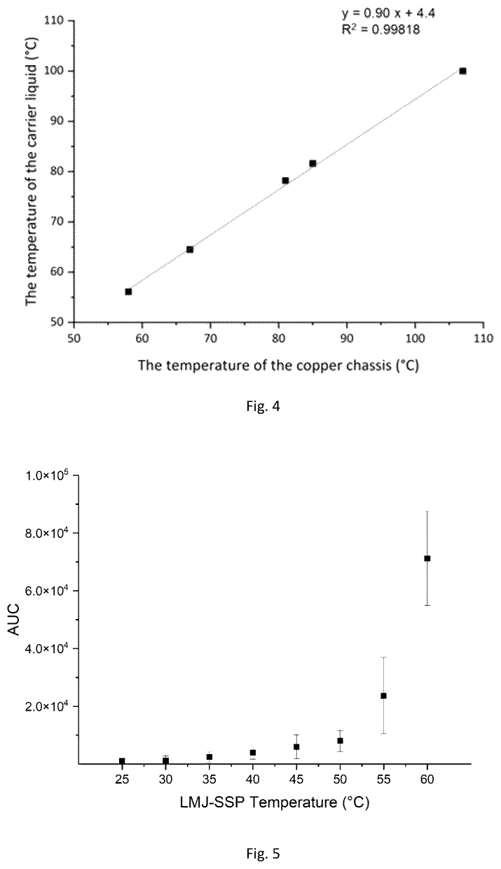

To accurately measure the temperature of the carrier liquid within the probe, various solvents (acetone, methanol, ethanol, acetonitrile, and deionized water) were pumped through the probe at a fixed flow rate (250 μL/min). The temperature of the copper chassis was then incrementally elevated to bring each solvent to its boiling point (FIG. 4). The measured boiling points served as data points to construct a calibration curve, correlating the measured boiling point of the carrier liquid inside the probe with the literature-reported boiling points of the solvents. The calibration curve was used to determine the temperature of the carrier liquid based on the measured temperature of the copper chassis. The calibration methodology ensured precise and reliable temperature control within the probe, laying the foundation for accurate and consistent analyses.

Positioning of the probe was achieved using an apparatus adapted from a 3D printer (Prusa IK3). As can be seen in FIG. 3, the printer head was modified 310 so that the probe 304, which was housed in the copper chassis 302 together with the heating element 306 and temperature sensor 308, could be mounted to it. Custom-built software was used to control movement and positioning of the probe in three dimensions across the sample, ensuring precision and accuracy in the probe placement and analysis procedure. Details of the positioning apparatus may be found in International Patent Application Publication No. WO 2022/256941.

The positioning apparatus and control software provided precise control of 3D movement of the probe, allowing for customizable coverage of the entire FFPE sample, or specific locations on the sample, or only a single location (spot) on the sample. At each spot the probe remains in position (i.e., the liquid microjunction in contact with the PPFE sample) for a sufficient duration to liquify and remove the paraffin (e.g., 1-3 seconds). The solvent with solubilized embedding medium collected from the sample may optionally be sent to a solvent trap and treated as waste. If an analysis is also being performed, the probe remains in position for a longer duration (e.g., up to 5 seconds, or longer). The solvent with analyte(s), metabolite(s), etc., collected from the sample after the initial period (e.g., 1-3 seconds) is collected and/or used for analysis. This versatility addresses the needs of diverse analytical applications, and importantly, preserves FFPE samples for future use and analysis. The latter may be of particular interest for rare samples.

### Example 2

This example describes optimization of heated LMJ-SSP parameters for preparing FFPE tissue sections.

Parameters that influence performance of the heated LMJ-SSP for deparaffinizing and analyzing samples using MS include the temperature and type of the carrier liquid, sampling time for each spot, and the temperature of the electrospray source. The latter is particularly significant as it affects ionization due to simultaneous spraying of metabolites and paraffin. Adjusting the temperature of the electrospray source to evaporate the paraffin, given its higher boiling point compared to analytes, enhances overall ionization of metabolites.

Optimizing analysis conditions for FFPE tissue sections poses a challenge due to sample heterogeneity. To address this, a more homogeneous FFPE tissue sample, specifically processed liverwurst FFPE tissue sections, was employed for optimization before transitioning to real/clinical sample analysis under optimal conditions. Signal-to-noise ratio improvement and enhanced reliability during optimization were achieved using a selected reaction monitoring (SRM) method. The glycerophospholipid metabolite at m/z 885.5 (PI 20:4/18:0) served as the parent ion, with arachidonate at m/z 303.2 as the product ion, fragmented using a collision energy of 35 V.

The mixed nature of paraffin, in that it comprises several hydrocarbons, results in a range of melting points (53-57° C.) rather than a sharp point. Consequently, the carrier liquid temperature needs to be at least at the higher end of this range to maximize paraffin solubilization and the deparaffinization process. However, the lowest boiling point of solvents in the carrier liquid (e.g., methanol) sets the maximum practical limit to which the probe can be heated. From the calibration curve (FIG. 4), when the copper chassis was set to 60° C., the carrier liquid temperature was determined to be 58.4±1.0° C. This temperature exceeds the melting point of paraffin, ensuring maximal deparaffinization and a higher area under the curve compared to lower temperatures (FIG. 5). Further temperature increases risk interrupting the flow due to the higher volatility of methanol very close to its boiling point. Consequently, the copper chassis temperature was maintained at a fixed 60° C. (corresponding to a carrier liquid temperature of 58.4±1.0° C.) throughout both the optimization and analysis phases.

The choice of carrier liquid is important as it significantly influences both extraction and ionization processes. The carrier liquid should efficiently deparaffinize FFPE tissue, facilitating exposure for subsequent extraction. Different mixtures of carrier liquids were systematically studied and compared to optimize the balance among the three crucial processes occurring during the analysis.

Xylene is known for its deparaffinization efficacy and was considered. However, given the direct connection of the probe to the mass spectrometer in an open environment, xylene was not used due to its toxicity. Instead, a xylene substitute (XS, MeOH:XS:NH₄OH:94.9:5.0:0.1% v/v) from Sigma-Aldrich, commonly used in histology for deparaffinization, was used and compared with a typical carrier liquid (MeOH:H₂O:NH₄OH:94.9:5.0:0.1% v/v).

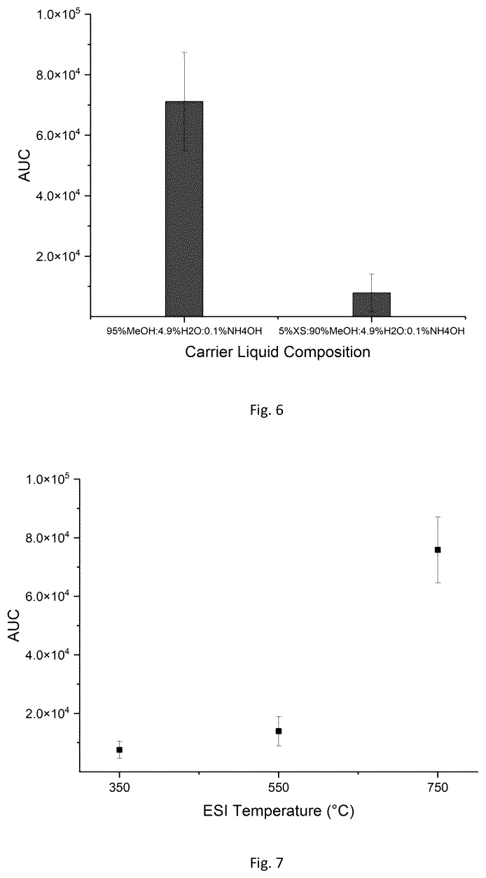

The results revealed that the xylene substitute (XS) introduced a high background noise, which was attributed to its ionizable nature. Conversely, the typical carrier liquid exhibited lower noise and higher analytical signals (FIG. 6). This outcome confirmed that the applied heating was sufficient for deparaffinizing the tissue and exposing it without the need for more aggressive solvents. The use of the typical carrier liquid ensures effective analysis while mitigating the challenges associated with toxic solvents in an open environment.

The carrier liquid plays a dual role in dissolving paraffin and extracting metabolites from the FFPE tissue sample. The liquified paraffin is sprayed along with the metabolites in the electrospray ionization (ESI) source. The high boiling point of paraffin necessitates the use of elevated temperatures in the source to ensure effective evaporation of the paraffin. Without this, metabolite ionization might be compromised as the liquid paraffin, sprayed along with the metabolites, could be lost to the exhaust line.

The impact of the ESI temperature is evident in FIG. 7, demonstrating that increasing the ESI temperature enhances the ionization of metabolites, aligning with expectations. This observation underscores the importance of maintaining an optimal ESI temperature to facilitate efficient metabolite ionization while ensuring effective evaporation of the liquid paraffin. The interplay between these factors is crucial for achieving accurate and reliable results in the analysis of FFPE tissue samples.

The sampling time, representing the duration during which the probe (liquid microjunction) is in contact with the FFPE tissue sample also requires careful consideration. Ideally, increasing the sampling time should result in an increased amount of extracted metabolites until extraction equilibrium is reached. Prior to equilibrium, the signal is expected to be lower, and after equilibrium, further increases in sampling time would yield minimal improvement in signal with an unnecessary extension in the overall analysis time.

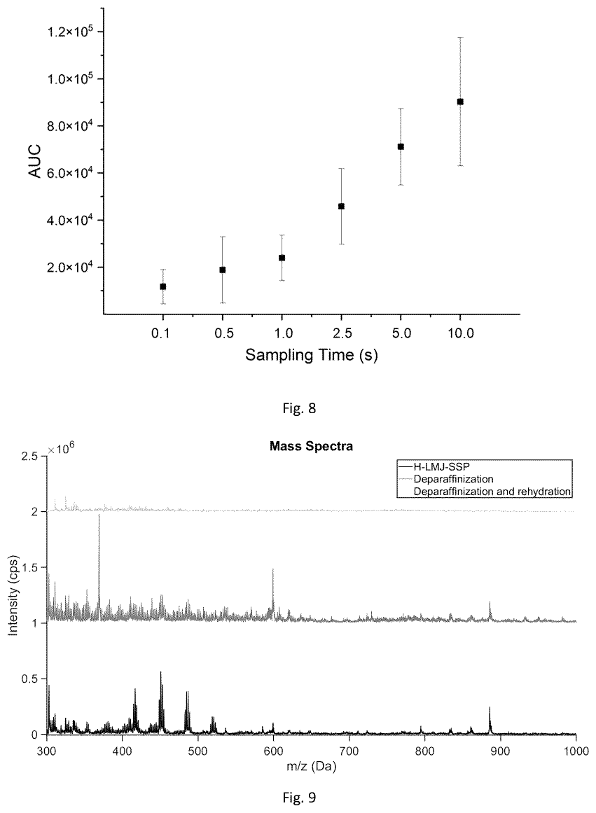

FIG. 8 illustrates that increasing the sampling time does indeed improve the signal. However, the transition from a 5 second to a 10 second sampling time does not lead to a significant improvement. Consequently, 5 seconds was deemed the optimal sampling time, striking the best balance between signal enhancement and analysis time. It is noteworthy that even with a 0.1 second sampling time an observable signal was obtained, indicating that the deparaffinization process is nearly spontaneous and the sampling time is not significantly influenced by deparaffinization. This optimization ensures efficient metabolite extraction while minimizing the overall analysis time.

The speed at which the probe sweeps over the FFPE tissue section during deparaffinization was studied using calf liver FFPE sections to determine the fastest sample preparation without compromising the outcome. For these FFPE tissue sections it was determined that a speed of 500 mm/s was the optimum condition for deparaffinization, ensuring efficient removal of paraffin without significant impact on the signal of metabolites. However, it will be appreciated that there may be different optimum speeds for different FFPE tissue sample. The optimized speed contributes to the overall efficiency of the deparaffinization process of the embodiments.

Using pork liver FFPE tissue sections, an optimized method according to one embodiment (FIG. 9, lower plot) was systematically compared with conventional deparaffinization methods, including the use of xylene (FIG. 9, middle plot) and the additional step of rehydration commonly employed in tandem with deparaffinization (FIG. 9, upper plot). Spectra obtained from the analysis of the pork liver FFPE tissue sections revealed that the direct analysis embodiments yielded superior results compared to analysis after conventional deparaffinization. It is noted that the signal at m/z 369.1 is related to the xylene substituent. The reduced intensity of this signal in the deparaffinized and rehydrated sample is attributed to metabolite loss during the rehydration step. This loss is a consequence of exposing the tissue to varying concentrations of ethanol solutions during rehydration, highlighting the advantages of the optimized embodiment in preserving and enhancing metabolite signals during analysis.

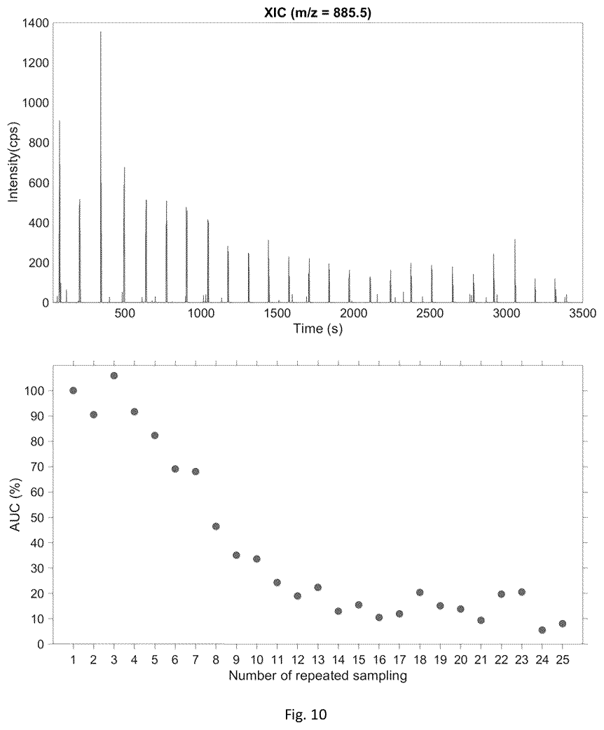

The embodiments demonstrate minimal destructiveness to the tissue section, even at the level of individual sampled spots. To investigate this aspect, the same spot on a calf liver tissue section was sampled repeatedly, 25 times (FIG. 10, upper plot), and the signal of m/z 885.5 was reported relative to the first sampling, considered as 100% (FIG. 10, lower plot). The results show that sampling the same spot over 25 times does not completely deplete the metabolite, and it required more than 6 repetitive samplings of the same spot to reduce the metabolite to less than 50% of the original amount in that spot. This demonstrates preservation of the tissue section and sampled spots during the analysis, confirming the non-destructive nature of the method.

Effectiveness of various deparaffinization solvents was studied using calf liver FFPE tissue sections. Desorption electrospray ionization-time of flight mass spectrometric imaging (DESI-TOF-MSI) was employed for mass spectrometric analysis. The solvents were ethyl acetate, toluene, and xylene. Mass spectrometric images clearly indicated that ethyl acetate and xylene exhibit superior deparaffinization compared to toluene. However, the more environmentally friendly nature of ethyl acetate makes it a preferable choice.

In another embodiment the deparaffinizing solvent may be, e.g., ethyl acetate and the probe temperature may be maintained at about 75° C. In another embodiment the solvent may be MeOH:H₂O:NH₄OH in a ratio of 94.9:5.0:0.1% v/v, delivered at a rate of 250 μL/min, and the analysis conducted in the negative polarity mode. The probe temperature may be maintained at 60° C. while the electrospray source temperature may be 750° C.

### Example 3

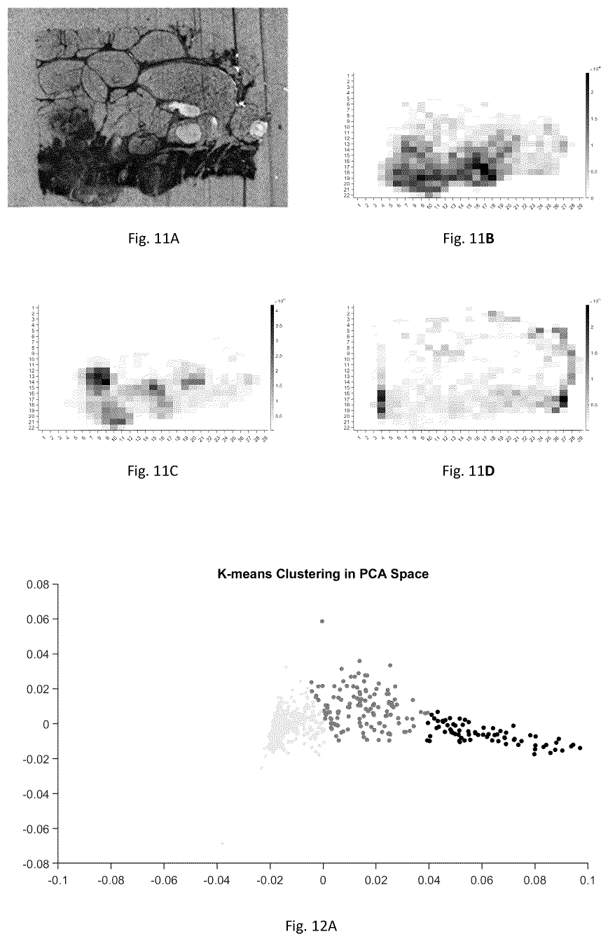

The effectiveness and applicability of the optimized method were validated by applying it to clinical samples, specifically melanoma FFPE tissue sections (FIG. 11A). Different regions within the tissue section, namely neoplastic, non-neoplastic, and paraffin-only regions, exhibited distinct spectra. The main markers were m/z 885.5 and 281.2 for the neoplastic region, while m/z 585.3 emerged as the primary marker for the non-neoplastic region. Heatmaps were generated for the spectra at each of the three markers (FIGS. 11B-11D, respectively).

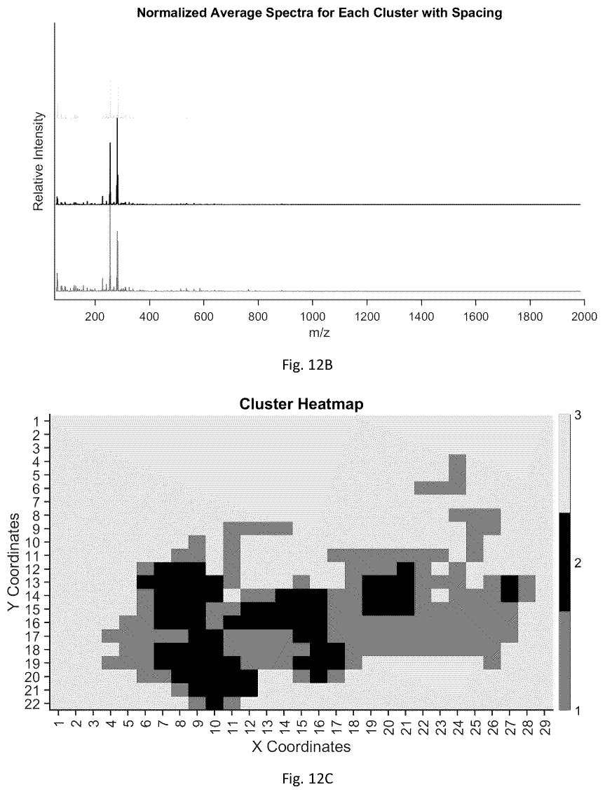

The MS spectra corresponding to the pixels of the heatmaps was subjected to Principal Component Analysis (PCA). The generated PCA results were then subjected to K-means clustering, categorizing the spectra into three groups based on their nature (FIG. 12A; paraffin (light gray), neoplastic (black), and non-neoplastic (dark gray)). The clustered heatmap aligns with the heatmaps of the identified markers, offering a visually accessible representation of the results (FIG. 12B). Importantly, the data analysis was entirely unsupervised, conducted on raw mass spectrometric data without any smoothing or correction. The clustered heatmap, with the neoplastic region presented in black, provides a clear visualization of the tissue sections. The location of the neoplastic region away from the margins, as indicated in the heatmap, suggests the substantially complete eradication of melanoma. This unsupervised analytical approach, coupled with heatmap visualization, enhances the interpretation and understanding of the different regions within the tissue sample.

### Example 4

A comparison of various parameters of a direct analysis embodiment and the conventional method for deparaffinization/mass spectrometric analysis of a typical FFPE tissue sample is given in the following table.

TABLE 1
Comparison of direct analysis embodiment and conventional
method for deparaffinization and MS analysis.

| PARAMETER | EMBODIMENT | | CONVENTIONAL APPROACH | |
|---|---|---|---|---|
| Automation | Completely | | Manual or partially automated | |
| Chemical solvent greenness | Greener (methanol) | | Less green (xylene) | |
| Destructiveness | Minimal | | Complete | |
| Sample preparation time for | 0 | min | 16 to 60 minutes | |
| single sample (10 × 20 mm tissue) | | | | |
| Solvent volume for single | 0 | mL | 50 mL (at least) | |
| sample preparation (10 × 20 mm | | | | |
| tissue) | | | | |
| Analysis time for single sample | ≈80 | min | ≈80 | min |
| (10 × 20 mm tissue) | | | | |
| Solvent volume for single | ≈20 | mL | ≈70 | mL |

sample preparation and analysis
(10 × 20 mm tissue)

A comparison of various parameters of an embodiment and the conventional method for deparaffinization of a typical FFPE tissue sample is given in the following table.

TABLE 2
Comparison of an embodiment and conventional method for deparaffinization.

| PARAMETER | EMBODIMENT | CONVENTIONAL APPROACH |
|---|---|---|
| Automation | Completely | Manual or partially automated |
| Chemical solvent greenness | Greener (ethyl acetate) | Less green (xylene) |
| Sample preparation time for | Less than 1 minute | 16 to 60 minutes |
| single sample (10 × 20 mm tissue) | | |
| Solvent volume for single | Less than 1 mL | At least 50 mL |
| sample (10 × 20 mm tissue) | | |

### Example 5

This example describes experiments that demonstrate sample extraction, collection, and analysis from various materials as may be carried out in, e.g., research or clinical settings. For each material sampling was carried out using a LMJ-SSP probe (without heating) and a positioning and control apparatus as described in Example 1. Samples obtained with the LMJ-SSP were collected into vials, and analysis was subsequently performed using flow injection analysis-mass spectrometry (FIA-MS) from the vials.

### Fresh-Frozen Tissue

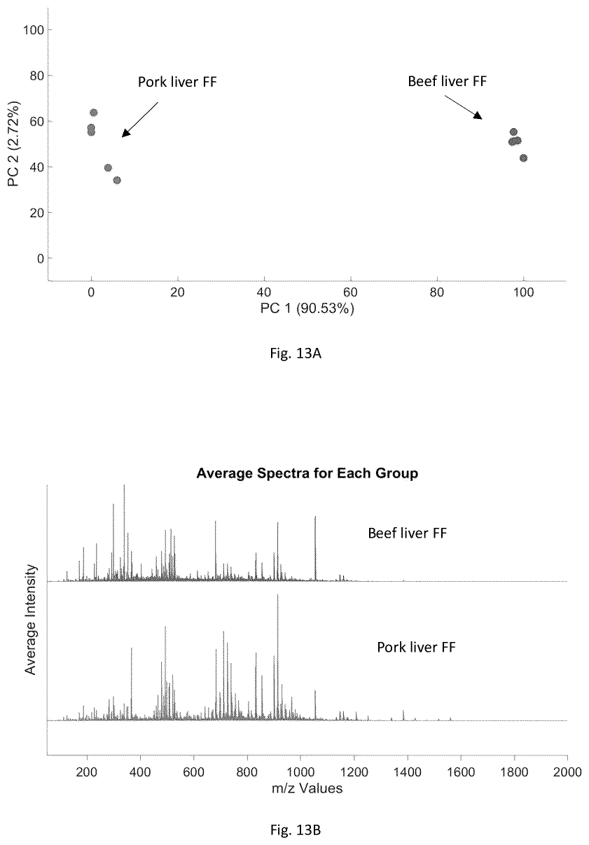

To extract metabolites from fresh-frozen (FF) beef and pork liver, the probe was set down and kept in contact with the tissue as it was moved across the tissue at a speed of 10 mm/min to sample an area of about 40 mm² using methanol at a flow rate of 225 μL/min. Each sample extract was collected in a separate vial. Then, 2 μL of each extract was removed from the vial and injected into a mass spectrometer (ESI-qTOF, Agilent) in negative polarity mode using flow injection analysis. The results (FIG. 13A) show a clear separation between the extracts. Furthermore, the average spectra for each extract reveal the different metabolites extracted under identical conditions (FIG. 13B).

It is important to note that the extracts are compatible with any analytical technique that accepts liquid samples.

### Cell Lines

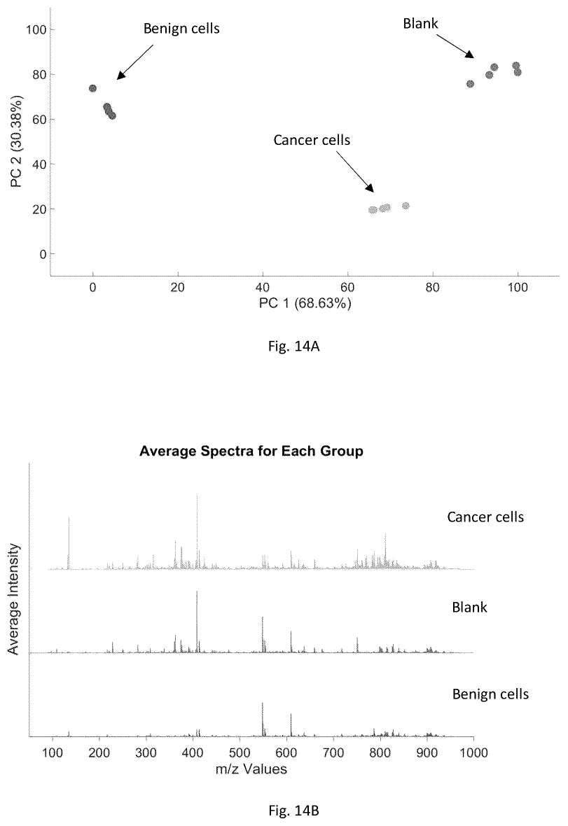

Samples were obtained from two cell lines, cancer cells (MDA-MB-231) and benign cells (MCF-10a), grown in Matrigel. Four spots from each cell line were extracted for 60 seconds each and pooled into a single vial. The extraction was performed using methanol at a flow rate of 225 μL/min, and each sample extract was collected in a separate vial. Then, 2 μL of each extract was injected into a mass spectrometer (ESI-qTOF, Agilent) in negative polarity mode using flow injection analysis. The results (FIG. 14A) show a clear separation between the cell lines and a blank (control). The average spectra (FIG. 14B) indicate that the metabolites are similar, as both cell lines are derived from epithelial cells, with noticeably higher metabolic activity observed in the cancer cells. Typically, significant sample preparation is required to extract metabolites from this type of sample, whereas the results demonstrate advantages of the direct analysis technique used in this embodiment.

### Bacterial and Fungal Colonies

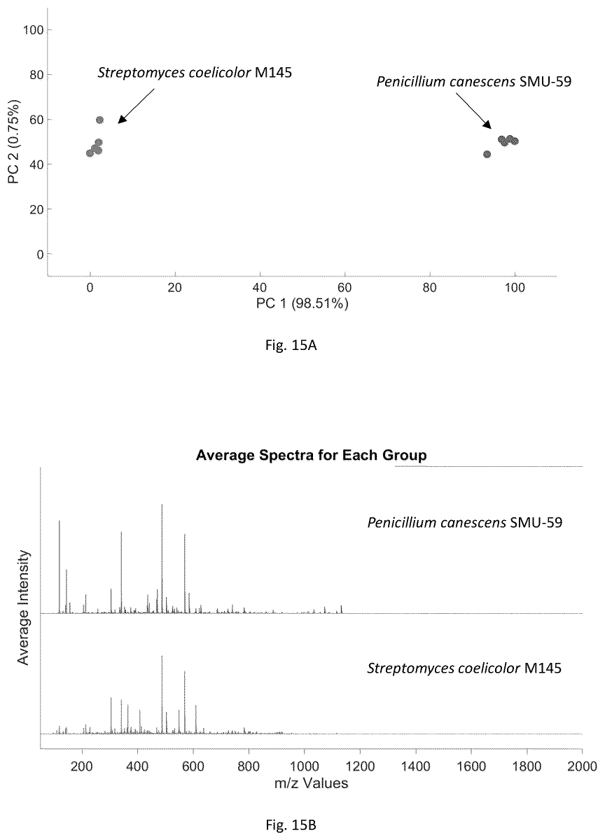

Samples were obtained from bacteria (Streptomyces coelicolor M145) and fungal (Penicillium canescens SMU-59) cell lines grown on agar. Two colonies of each organism were sampled directly from the agar plate (sampling period of one minute) using methanol at a flow rate of 225 μL/min. Each sample extract was collected in a separate vial. Then 2 μL of each extract was injected into a mass spectrometer (ESI-qTOF, Agilent) in positive polarity mode using flow injection analysis. The results (FIGS. 15A and 15B) confirm that the organisms can be distinguished using direct analysis according to this embodiment.

All cited documents are incorporated herein by reference in their entirety.

### EQUIVALENTS

Those of ordinary skill in the art will recognize, or be able to ascertain through routine experimentation, equivalents to the embodiments described herein. Such equivalents are within the scope of the invention and are covered by the appended claims.

### REFERENCES

[1] Gomez-Gomez, A.; Sabbaghi, M.; Haro, N.; Albanell, J.; Menéndez, S.; González, M.; Gil-Gómez, G.; Rovira, A.; Pozo, O. J., Talanta 2021, 223, 121740.
[2] Aoki, Y.; Toyama, A.; Shimada, T.; Sugita, T.; Aoki, C.; Umino, Y.; Suzuki, A.; Aoki, D.; Daigo, Y.; Nakamura, Y.; Sato, T.-A., Proceedings of the Japan Academy. Series B, Physical and biological sciences 2007, 83 (7), 205-214.
[3] Gaifulina, R.; Caruana, D. J.; Oukrif, D.; Guppy, N. J.; Culley, S.; Brown, R.; Bell, I.; Rodriguez-Justo, M.; Lau, K.; Thomas, G. M. H., Analyst 2020, 145 (4), 1499-1510.
[4] Kalantari, N.; Bayani, M.; Ghaffari, T., Analytical Biochemistry 2016, 507, 71-73.
[5] Mitsa, G.; Guo, Q.; Goncalves, C.; Preston, S. E. J.; Lacasse, V.; Aguilar-Mahecha, A.; Benlimame, N.; Basik, M.; Spatz, A.; Batist, G.; Miller, W. H.; del Rincon, S. V.; Zahedi, R. P.; Borchers, C. H., International Journal of Molecular Sciences 2022, 23 (8), 4443.
[6] Mansour, A.; Chatila, R.; Bejjani, N.; Dagher, C.; Faour, W. H., MethodsX 2014, 1, 90-95.
[7] Prema, V.; Prasad, H.; Srichinthu, K. K.; Kumar, S. S.; Rajkumar, K.; Marudhamani, C., Journal of pharmacy & bioallied sciences 2020, 12 (Suppl 1), S623-S630.
[8] Hermann, J.; Noels, H.; Theelen, W.; Lellig, M.; Orth-Alampour, S.; Boor, P.; Jankowski, V.; Jankowski, J., Analytical and Bioanalytical Chemistry 2020, 412 (6), 1263-1275.
[9] Marinho, P. F.; Hanscheid, T., MethodsX 2023, 10, 102079.
[10] Steven, R. T.; Niehaus, M.; Taylor, A. J.; Nasif, A.; Elia, E.; Goodwin, R. J. A.; Takats, Z.; Bunch, J., Analytical Chemistry 2022, 94 (28), 9970-9974.

[11] Simon, D. J.; Oleschuk, R. D., Analyst 2021.

1. A device for preparing a tissue for analysis, comprising:
a first conduit adapted to transport at least one solvent, the first conduit having a distal opening that delivers the at least one solvent to a selected location on the tissue;
a second conduit adapted to collect a sample comprising the at least one solvent from the tissue and transport the sample to at least one of a waste disposal, a storage container, and a sample analyzer.

2. The device of claim 1, wherein the tissue is an embedded tissue, the device comprising:
a heater proximal to the distal opening of the first conduit, the heater adapted to heat the at least one solvent to a temperature sufficient to melt an embedding medium of the embedded tissue at the selected location on the embedded tissue;
wherein the sample comprises the at least one solvent and liquified embedding medium;
wherein the second conduit is adapted to collect and transport the sample away from the selected location on the embedded tissue.

3. The device of claim 2, comprising a controller that regulates the temperature of the heater.

4. The device of claim 1, wherein the first conduit and the second conduit are substantially coaxial;
wherein the second conduit is inside the first conduit.

5. The device of claim 1, further comprising positioning apparatus;
wherein the device is removably attached to the positioning apparatus;
wherein the positioning apparatus provides adjustment of a position of the device along one or more of X, Y, and Z axes;
wherein the positioning apparatus enables positioning of the distal opening of the device at the selected location on the tissue.

6. The device of claim 1, wherein the sample analyzer comprises liquid extraction surface analysis (LESA), water assisted laser desorption ionization mass spectrometry (WALDI), desorption electrospray ionization mass spectrometry (DESI), nano-DESI, matrix-assisted laser desorption ionization (MALDI), electrospray ionization mass spectrometry (ESI), electron ionization (EI), atmospheric chemical ionization (APCI), liquid chromatography-mass spectrometry (LC-MS), capillary electrophoresis-mass spectrometry (CE-MS), or gas chromatography-mass spectrometry (GC-MS).

7. The device of claim 2, wherein the embedding medium comprises paraffin.

8. The device of claim 2, wherein the embedded tissue comprises a formalin-fixed paraffin-embedded (FFPE) tissue.

9. The device of claim 1, wherein the second conduit is adapted to collect the sample comprising the at least one solvent from the tissue and transport the sample to the storage container.

10. The device of claim 1, wherein the second conduit is adapted to collect the sample comprising the at least one solvent from the tissue and transport the sample to the sample analyzer.

11. The device of claim 2, wherein the second conduit is adapted to collect the sample comprising the at least one solvent and liquified embedding medium from the tissue and transport the sample to the waste disposal.

12. The device of claim 2, wherein the second conduit is adapted to collect the sample comprising the at least one solvent and liquified embedding medium from the tissue and transport the sample to the sample analyzer.

13. The device of claim 2, wherein the sample is continuously collected during first and second portions of a sampling period;
wherein the sample collected during the first portion of the sampling period comprises the at least one solvent and liquified embedding medium and the sample collected during the second portion of the sampling period comprises the at least one solvent substantially without the liquified embedding medium
wherein the sample collected during the second portion of the sampling period is transported to the sample analyzer.

14. A mass spectrometry probe comprising the device of claim 1.

15. A method for preparing a tissue for analysis, comprising:
using a first conduit to transport at least one solvent, the first conduit having a distal opening that delivers the at least one solvent to a selected location on the tissue;
using a second conduit to collect a sample comprising the at least one solvent from the tissue and transport the sample to at least one of a waste disposal, a storage container, and a sample analyzer.

16. The method of claim 15, wherein the tissue is an embedded tissue, comprising:
disposing a heater proximal to the distal opening of the first conduit, the heater adapted to heat the at least one solvent to a temperature sufficient to melt an embedding medium of the embedded tissue at the selected location on the embedded tissue;
using a second conduit to collect and transport the sample comprising the at least one solvent and liquified embedding medium away from the selected location on the tissue section;
wherein the embedding medium is removed from the tissue section only at the selected location.

17. The method of claim 16, comprising regulating the temperature of the heater to maintain the at least one solvent at the temperature sufficient to melt the embedding medium at the selected location on the tissue section.

18. The method of claim 15, wherein the sample analyzer comprises liquid extraction surface analysis (LESA), water assisted laser desorption ionization mass spectrometry (WALDI), desorption electrospray ionization mass spectrometry (DESI), nano-DESI, matrix-assisted laser desorption ionization (MALDI), electrospray ionization mass spectrometry (ESI), electron ionization (EI), atmospheric chemical ionization (APCI), liquid chromatography-mass spectrometry (LC-MS), capillary electrophoresis-mass spectrometry (CE-MS), or gas chromatography-mass spectrometry (GC-MS).

19. The method of claim 16, wherein the method enables sampling of the embedded tissue without removing the embedding medium from other locations of the embedded tissue.

20. The method of claim 16, wherein the embedding medium comprises paraffin.

21. The method of claim 16, wherein the embedded tissue comprises a formalin-fixed paraffin-embedded (FFPE) tissue.
